(19) United States
(12) Patent Application Publication
(10) Pub. No.: US 2025/0254646 A1
(43) Pub. Date: Aug. 7, 2025

(54) SYSTEMS AND METHODS FOR CARRIER PHASE POSITIONING

(71) Applicant: ZTE CORPORATION, Shenzhen (CN)

(72) Inventors: Cong WANG, Shenzhen (CN); Chuangxin JIANG, Shenzhen (CN); Focai PENG, Shenzhen (CN); Mengzhen LI, Shenzhen (CN); Qi YANG, Shenzhen (CN); Junpeng LOU, Shenzhen (CN)

(73) Assignee: ZTE CORPORATION, Shenzhen (CN)

(21) Appl. No.: 18/899,984

(22) Filed: Sep. 27, 2024

Related U.S. Application Data
(63) Continuation of application No. PCT/CN2023/076858, filed on Feb. 17, 2023.

(51) Int. Cl. H04W 64/00; H04B 17/20; H04W 24/10

(52) U.S. Cl. CPC H04W 64/00; H04B 17/255; H04W 24/10

(57) ABSTRACT

The present arrangement relate to systems, methods, and non-transitory computer-readable media for reporting a Channel State Information (CSI) report, the CSI report including a CSI part 1 and a CSI part 2; and communicating, by a wireless communication device with a network, based on the CSI report.

### CROSS-REFERENCE TO RELATED APPLICATIONS

This application claims the benefit of priority under 35 U.S.C. § 120 as a continuation of PCT Patent Application No. PCT/CN2023/076858, filed on Feb. 17, 2023, the disclosure of which is incorporated herein by reference in its entirety.

### TECHNICAL FIELD

The disclosure relates generally to wireless communications and, more particularly, to carrier phase positioning.

### BACKGROUND

Many positioning technologies are proposed for 5G-enabled networks to achieve high accuracy positioning for network devices. However, with increasing requirements of different application scenarios on positioning accuracy, existing positioning techniques can hardly meet growing demand for communication performance as desired.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

At least one aspect is directed to a wireless communication method. The method can include determining, by a wireless communication device, a first period. The method can include the wireless communication device configured to measure a carrier phase of a reference signal for positioning within the first period.

At least one aspect is directed to a wireless communication method. The method can include receiving, by a wireless communication node from a wireless communication device, a capability report indicating capability of the wireless communication device to measure a carrier phase of a reference signal for positioning. The method can include the carrier phase of the reference signal configured to be measured within a period.

At least one aspect is directed to a wireless communication method can include receiving, by a wireless communication node from a network node, configuration information of a reference signal for positioning.

At least one aspect is directed to a method of wireless communication. The method can include reporting, by a network node, a measurement result of a reference signal for positioning.

In some examples, the wireless communication device refers to a user equipment (UE) or a positioning reference unit (PRU), the network node refers to the core network or location management function (LMF) or a gNB.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication system, according to some arrangements.

FIG. 2 illustrates block diagrams of an example base station and an example user equipment device, according to some arrangements.

FIG. 3 illustrates an example carrier phase positioning configuration, in accordance with present implementations.

FIG. 4 illustrates an example carrier phase positioning configuration with PRU, in accordance with present implementations.

FIG. 5 illustrates an example communication diagram, in accordance with present implementations.

FIG. 6 illustrates an example calibration architecture, in accordance with present implementations.

FIG. 7 illustrates an example priority subset architecture, in accordance with present implementations.

FIG. 8 illustrates an example positioning configuration, in accordance with present implementations.

FIG. 9 illustrates an example method of carrier phase positioning, in accordance with present implementations.

FIG. 10 illustrates an example method of carrier phase positioning, in accordance with present implementations.

FIG. 11 illustrates an example method of carrier phase positioning, in accordance with present implementations.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

To improve positioning accuracy, carrier phase positioning (CPP) technology is thereupon leveraged as an auxiliary tool to ameliorate deficiencies in current positioning technology. For example, this technical solution is directed at least to technical improvements to TDOA (Time Difference of Arrival), AOA (Angle of Arrival), AOD (Angle of Departure), Multi-RTT (Multiple-Round Trip Time) and other positioning methods to achieve precise positioning functions, by collecting the phase information of different positioning reference signals (PRS) or sounding reference signals (SRS). The measured/reported phase information are used to improve the positioning performance as well as specify possible error sources.

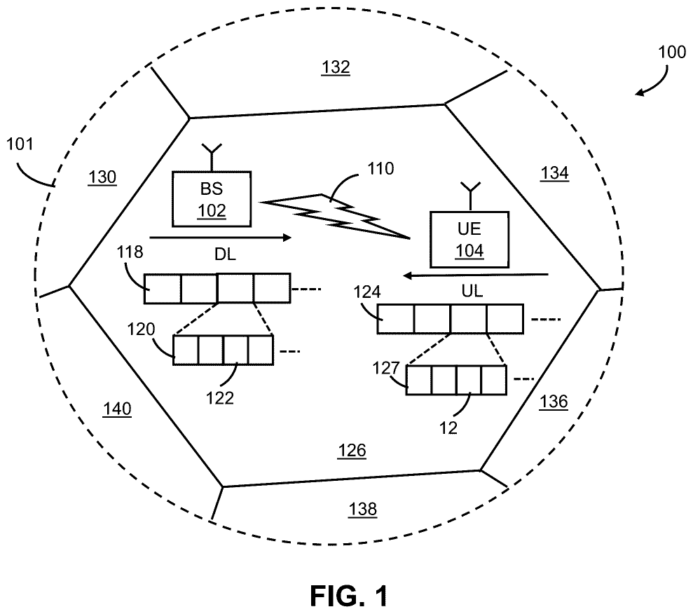

FIG. 1 illustrates an example wireless communication system 100 in which techniques disclosed herein may be implemented, in accordance with an implementation of the present disclosure. In the following discussion, the wireless communication system 100 can implement any wireless network, such as a cellular network or a narrowband Internet of things (NB-IoT) network, and is herein referred to as system 100. Such an example system 100 includes a BS 102 and a UE 104 that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one BS operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes”, generally, which can practice the methods disclosed herein. Such communication nodes may be capable of wireless and/or wired communications, in accordance with various implementations of the present solution.

In some implementations, the wireless communication system 100 may support Multiple-Input Multiple-Output (MIMO) communication. For example, MIMO is a key technology in new radio (NR) systems. MIMO may be functional in both frequency division duplex (FDD) and time division duplex (TDD) systems, among others. MIMO technologies may utilize reporting mechanisms such as Channel Status Information (CSI) to support communication. CSI reports may include various types, parts, groups, and fields. The techniques described herein may provide enhancements to various aspects of the CSI report and reporting process. For example, a wireless communication device may receive, by a wireless communication device from a network, multiple reference signals and a configuration parameter. The wireless communication device may determine a CSI report based on the multiple reference signals and the configuration parameter, where the CSI report comprises CSI part 1 and CSI part 2. The wireless communication device may report, to the network, the CSI report. In some cases, the reporting process may include one or more of the following: the configuration parameter may be configured for enabling two or more Channel Quality Indicators (CQIs) in the CSI report, the reference signals are aperiodic or semi-persistent, and each of a CSI window length, FDD or TDD basic unit size, an offset between two CSI reference signal (CSI-RS) resources, and a length of FDD or TDD basic vector is larger than or equal to a threshold. Additionally, or alternatively, the wireless communication device may send, to the network, a User Equipment (UE) capability report indicating that the wireless communication device supports a number of CQI reports, where the number is a positive integer. The wireless communications system may implement codebooks to further support CSI reporting, among other various uses.

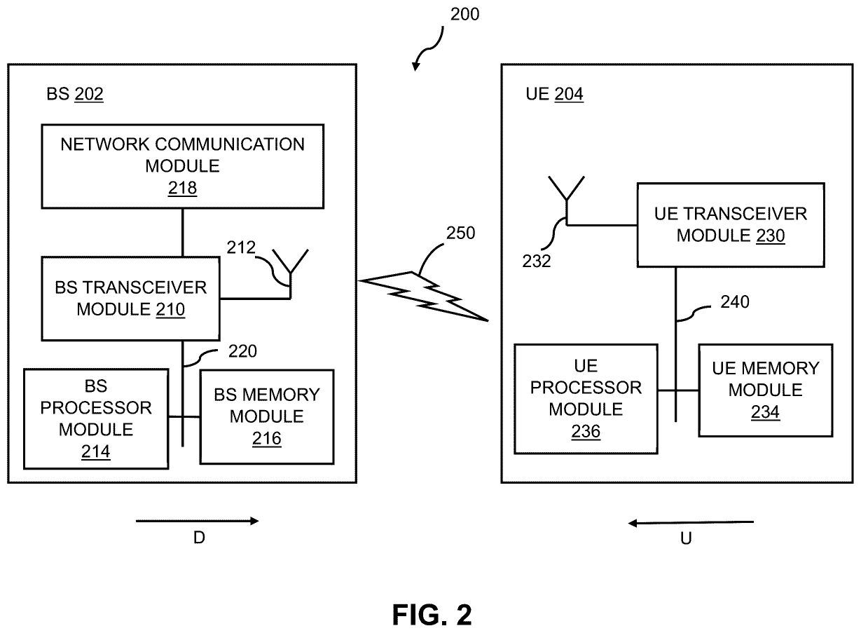

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a BS 202 and a UE 204. The BS 202 includes a Base Station (BS) transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an uplink transceiver 230 that includes a Radio Frequency (RF) transmitter and a RF receiver each including circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each including circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the BS transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 230 and the BS transceiver 210 are configured to support industry standards such as the Long Term Evolution (LTE) and emerging 5G and 6G standards, and the like. It is understood, however, that the present disclosure is not necessarily limited in application to a particular standard and associated protocols. Rather, the UE transceiver 230 and the BS transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 can be various types of user devices such as a mobile phone, a smart phone, a Personal Digital Assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the methods described in connection with the implementations disclosed herein may be implemented directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the BS 202 that enable bi-directional communication between BS transceiver 210 and other network components and communication nodes configured to communication with the BS 202. For example, network communication module 218 may be configured to support internet or WiMAX traffic. In a typical deployment, without limitation, network communication module 218 provides an 802.3 Ethernet interface such that BS transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

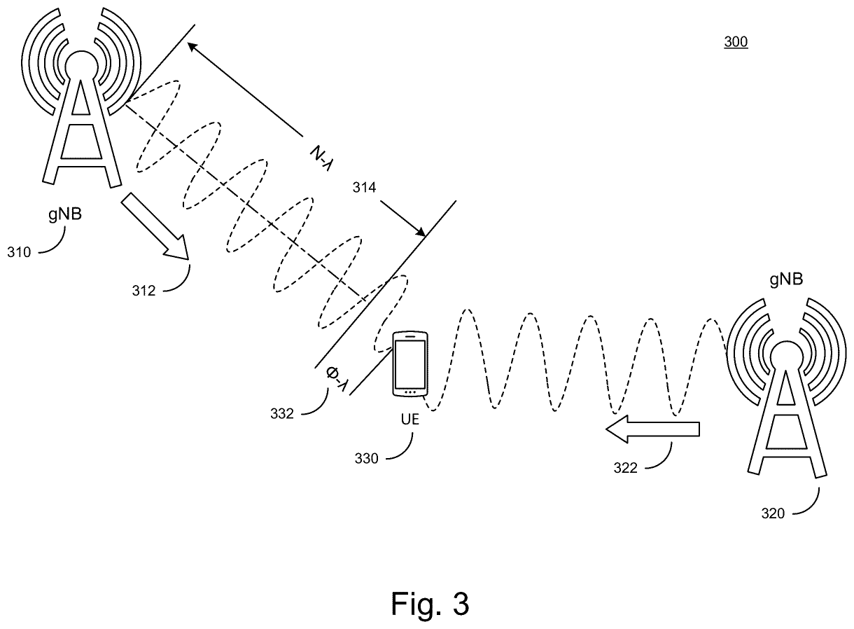

FIG. 3 depicts an example carrier phase positioning configuration, in accordance with present implementations. As illustrated by way of example in FIG. 3, an example carrier phase positioning configuration 300 can include at least base stations 310 and 320, transmissions with UE 312 and 322, a transmissions integer part of carrier phase 314, a UE 330, and a fractional part of carrier phase 332.

An application scenario for carrier phase based positioning is described. For example, for user equipment (UE), e.g., a target device, the carrier phase measured on signal from gNB is:

$$[ N + ϕ / ( 2 π ) ] λ = D + w \qquad ( Equ . 1 )$$

where, λ=c/f is the wavelength of the radio signal (c is the speed of light, f is the carrier frequency of the radio wave transmitted by the transmitter), N is the integer part of carrier phase (the number of full wavelengths experienced between the transmitter and the receiver), ϕ is the carrier phase, ϕ/(2π) denotes the fractional part of carrier phase, D is the distance between UE and gNB (LOS distance), and w is measurement noise.

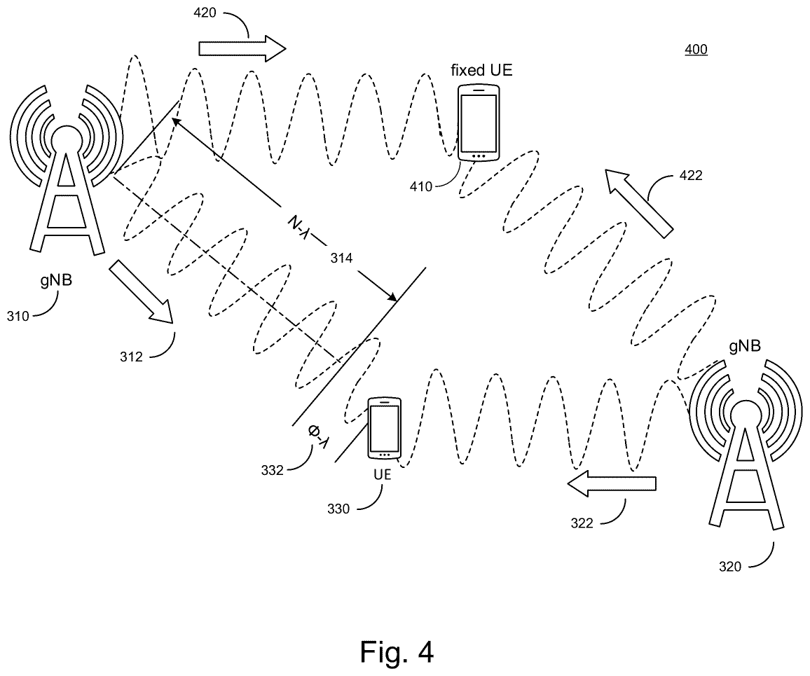

FIG. 4 depicts an example carrier phase positioning configuration with positioning reference unit (PRU), in accordance with present implementations. As illustrated by way of example in FIG. 4, an example carrier phase positioning configuration with PRU 400 can include at least a fixed UE 410, and transmissions with the fixed UE 420 and 422.

Carrier phase positioning with a PRU is described. For more accurate evaluation, carrier phase positioning allows a system introducing a PRU to help the location measurement for the target device. For each pair of gNB and UE, the equation referring to the relationship between measurement distance and carrier phase is summarized in Equ. 1. Some technologies make use of the double difference between different UE and gNB, to alleviate or eliminate the side effect of measurement error, further achieve better positioning performance.

At least one aspect is directed to measurement period determination with a measurement gap. In certain TDOA positioning procedure, when a physical layer receives last of NR-TDOA-ProvideAssistanceData message and NR-TDOA-RequestLocationlnformation message from LMF, the UE shall be able to measure multiple downlink (DL) reference signal time difference (RSTD) measurements during the measurement period T_{RSTD,Total} defined as:

$${T}_{RSTD , Total} = {\sum }_{i = 1}^{L} {T}_{RSTD , i} + ( L - 1 ) * {max}_{i = 1}^{L} ( {T}_{effect , i} )$$

where max( ) is an operation for maximum. For example, T_{RSTD,i} is the measurement period for PRS RSTD measurement in positioning frequency layer i as specified below:

$${T}_{RSTD , i} = ( {k}_{multiTEG , i} * {CSSF}_{PRS , i} * ceil ( {K}_{p , PRS , i} ) * {N}_{RxBeam , i} * ⌈ \frac{{N}_{P R S , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i}$$

For carrier phase (CP) assisted positioning procedure, DL CP measurement during the measurement period T_{CP,Total} in RRC_CONNECTED state could be defined as:

$${T}_{CP , Total} = {\sum }_{i = 1}^{L} {T}_{CP , i} + ( L - 1 ) * {max}_{i = 1}^{L} ( {T}_{effect , i} )$$

$${T}_{CP , i} = ( {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} ,$$

where N_{RxBeam,i} is the UE Rx beam sweeping factor, CSSF_{PRS,i} is the carrier-specific scaling factor for NR PRS-based positioning measurements in positioning frequency layer i, K_{p,PRS,i} is a scaling factor for a positioning frequency layer to be measured within the associated measurement gap pattern, N_{PRS,i}^{slot} is the maximum number of DL PRS resources in positioning frequency layer i configured in a slot, L_{available_PRS,i} is the time duration of available PRS in the positioning frequency layer i to be measured during T_{available_PRS,i}, Nₛₐₘₚₗₑ is the number of PRS CP measurement samples, T_{last,i} is the measurement duration for the last PRS CP sample in positioning frequency layer i, T_{effect,i} is the periodicity of the PRS CP measurement in positioning frequency layer i. With this method, the UE can measure the carrier phase of PRS within the CP measurement period, the positioning efficiency can be improved. For carrier phase (CP) assisted positioning procedure, DL CP measurement during the measurement period T_{CP,Total} in RRC_INACTIVE state could be defined as:

$${T}_{CP , T otal} = {\sum }_{i = 1}^{L} {T}_{CP , i} + ( L - 1 ) * {max}_{i = 1}^{L} ( {T}_{effect , i} ) ,$$

$$where {T}_{CP , i} = ( {K}_{carrier \_ PRS} * {N}_{R x B eam , i} * ⌈ \frac{{N}_{PRS , i}^{slot}}{N} ⌉ * ⌈ \frac{{L}_{available \_ PRS , i}}{N} ⌉ * {N}_{sample} - 1 ) * {T}_{effect , i} + {T}_{l ast , i} ,$$

where K_{carrier_PRS} is a scaling factor for PRS-based NR positioning measurements in RRC_INACTIVE, N_{RxBeam,i} is a scaling factor for Rx beam sweeping, N_{PRS,i}^{slot} is a maximum number of DL PRS resources of positioning frequency layer i configured in a slot, N′ is UE capability for number of DL PRS resources that it can process in a slot, L_{available_PRS,i} is a time duration of available PRS to be measured in the positioning frequency layer i to be measured during T_{PRS,i}, Nₛₐₘₚₗₑ is a number of PRS CP measurement sample, Tₗₐₛₜ is a measurement duration for the last PRS CP sample, including the sampling time and processing time, T_{effect,i} is a periodicity of PRS CP measurement in positioning frequency layer i.

For example, the PRS processing capability for CP measurement can be the same as or different from that of RSTD measurement. For example, the UE can report PRS processing capability for CP measurement, which is the same as or different from that of RSTD measurement, comprises the duration N_{cp} of DL-PRS symbols in units of ms a UE can process every T_{cp} ms, this report may contain one or more information elements (IEs). For example, the report can contain an IE including or corresponding to values for N_{cp}. For example, the report can contain an IE including or corresponding to values for T_{cp}. For example, T_{effect,i} is the periodicity of the PRS CP measurement in positioning frequency layer i defined as:

$${T}_{effect , i} = ⌈ \frac{{T}_{i}}{{T}_{available \_ PRS , i}} ⌉ * {T}_{available \_ PRS , i}$$

For example, Tᵢ corresponds to the value of T_{cp} as defined above, N (in T_{CP,i} calculation equation) correspond to the value of N_{cp} as defined above.

For example, a scaling factor k_{multiPEG,i} for measurement of a same PRS resource with multiple Rx PEGs (phase error group) if PEG can be added in T_{CP,i} calculation equation as follows:

$${T}_{CP , i} = ( {k}_{multiPEG , i} * {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i}$$

Other parameters (include N_{RxBeam,i}, CSSF_{PRS,i}, K_{p,PRS,i}, N_{PRS,i}^{slot}, L_{available_PRS,i}, T_{available_PRS,i}, Nₛₐₘₚₗₑ, T_{last,i} and T_{effect,i}) can be the same as that of RSTD measurement.

For example, a UE can report the scaling factor for RSTD and CP measurement. This report may contain various IEs. For example, the report can contain an IE including or corresponding to a scaling factor for RSTD measurement. For example, the report can contain an IE including or corresponding to scaling factor for CP measurement.

For example, the total measurement period for PFL i can be defined as:

$${T}_{RSTD \_ CP , i} = S {F}_{RSTD} * {T}_{R S T D , i} + {SF}_{CP} * {T}_{CP , i}$$

The total measurement period for all PFLs T_(RSTD_CP,Total) defined as:

$${T}_{RSTD \_ CP , Total} = {\sum }_{i = 1}^{L} {T}_{RSTD \_ CP , i} + ( L - 1 ) * {max}_{i = 1}^{L} ( {T}_{effect , i} )$$

For example, the total measurement period for all PFLs T_{RSTD_CP,Total} can be calculated as:

$${T}_{RSTD \_ CP , Total} = S {F}_{R S T D} * {T}_{R STD , total} + S {F}_{C P} * {T}_{CP , total}$$

Where the scaling factor is between 0 and a pre-configured value.

For CP-assisted positioning, a UE can measure the CP together with other attributes. For example, a UE can report PRS processing capability for CP and other attributes measurement. For example, the report can comprise the duration N_{combination} of DL-PRS symbols in units of ms. For example, a UE can process every T_{combination} ms, this report may contain various IEs. For example, the report can contain an IE including or corresponding to values for N_{combination}. For example, the report can contain an IE including or corresponding to values for T_{combination}. For example, the report can contain an IE including or corresponding to measurement items. For example, other attributes can comprise one of the following: RSTD, RSRP, RSRPP, UE Rx-Tx difference and other measurement options. For example, the UE can measure multiple DL PRS measurements during the measurement period T_{combined,Total} defined as the following, where T_{combined,i} can be calculated using the combined UE measurement capability:

$${T}_{combined , Total} = {\sum }_{i = 1}^{L} {T}_{combined , i} + ( L - 1 ) * {max}_{i = 1}^{L} ( {T}_{e f f e c t , i} )$$

Optionally, the UE can report PRS processing capability within PPW (without measurement gap). For example, the PPW configuration for CP positioning can include two offsets for N2 and T2, the report may contains various IEs. For example, the report can contain an IE including or corresponding to values for N2. For example, the report can contain an IE including or corresponding to values for T2. For example, the report can contain an IE including or corresponding to an offset for N2, i.e., ΔN2. For example, the report can contain an IE including or corresponding to an offset for T2, i.e., ΔT2. For example, the report can contain an IE including or corresponding to measurement items.

For example, the UE capability for PPW can become (N2+ΔN2, T2+ΔT2). Compared with measuring a single attribute, the duration of measuring multiple attributes will be shorter or the period will be longer. In general, ΔN2 is less than 0 and ΔT2 is greater than 0.

The measurement period T_{combined,Total} can be defined as the following, where T_{RSTD_wo_gap,i} is the measurement period for multiple PRS attributes measurement in positioning frequency layer i:

$${T}_{combined , Total} = {\sum }_{i = 1}^{L} ( {T}_{RSTD \_ wo \_ gap , i} + Δ T 2 ) + ( L - 1 ) * max ( {T}_{e f f e c t , i} )$$

For example, compared with a single attribute measurement, a UE can measure multiple attribute measurements during the measurement period T_{RSTD_CP,Total} defined as (take RSTD as an example), where SF is a scaling factor between 1 and a pre-determined value:

$${T}_{RSTD \_ CP , Total} = S {F}^{*} {T}_{R S T D , Total}$$

The above measurement period calculation process is within the measurement gap. For the cases without measurement gap, similar parameters (include measurement period related parameters T_{CP,Total}, T_{CP,i}, k_{multiPEG,i}, T_{combined,Total}, T_{combined,i} and scaling factors SF, SF_{CP}, SF_{RSTD}) can also be used, the UE capability report related parameters (N_{cp}, T_{cp}, N_{combination}, T_{combination}) can be included in PPW (PRS Processing Window) processing capability.

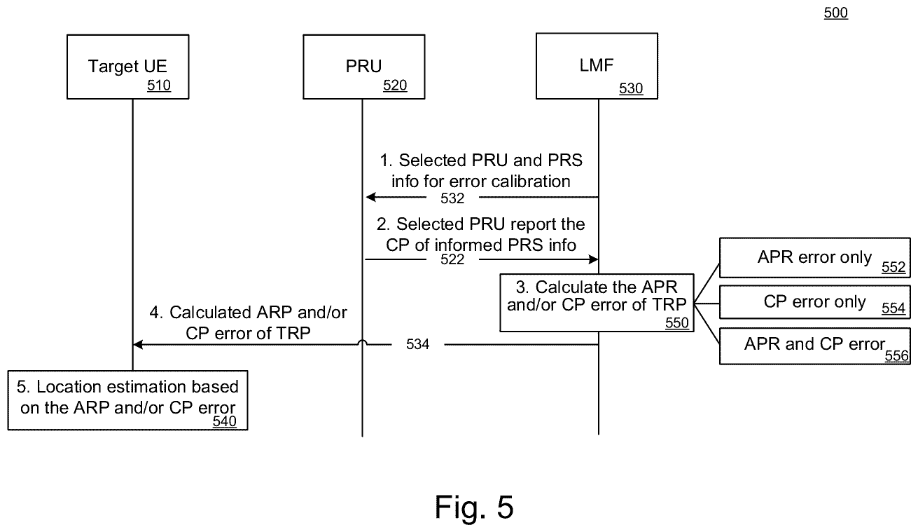

FIG. 5 depicts an example communication diagram, in accordance with present implementations. As illustrated by way of example in FIG. 5, an example communication diagram 500 can include at least a target UE 510, a PRU 520, a report transmission 522, an LMF 530, a PRU or PRS selection transmission 532, an error transmission 534, an estimation output 540, an error output 550, and error classification outputs 552, 554 and 556. In a CP-assisted positioning process, there might be antenna reference point (ARP) location error and initial carrier phase error on TRP transmitting antenna. For a TRP, if the ARP error or carrier phase corresponding to the same beam set remains unchanged, the explicit ARP error or carrier phase error can be evaluated with the help of multiple PRU.

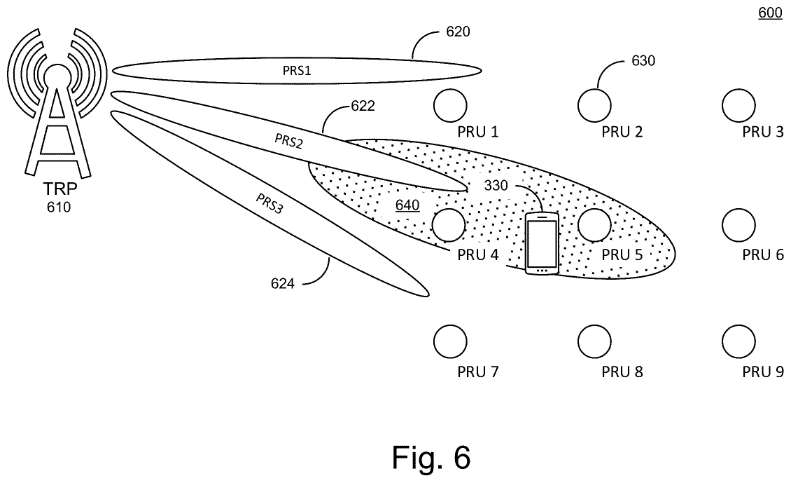

FIG. 6 depicts an example calibration architecture, in accordance with present implementations. As illustrated by way of example in FIG. 6, an example calibration architecture 600 can include at least a TRP 610, PRS transmissions 620, 622 and 624, PRU locations 630, and a UE region 640.

For example, a first part can include PRU/PRS selection. The criterion for PRU selection to calibrate the ARP error or carrier phase error comprises: 1) The selected PRU can receive the same PRS with the target UE, and 2) the selected PRU can be in the line of sight (LOS) direction of TRP. For example, there are multiple PRU located around a UE, and a TRP is transmitting multiple PRS during the positioning process. PRU 4 and PRU 5 are selected as reference PRUs to calibrate the error resources. In this scene, PRU 4, PRU 5 and target UE share the same ARP location error or carrier phase error. LMF can send the selected PRU ID and PRS info to the PRU in an LTE positioning protocol (LPP) message, which comprises various IEs. For example, the IE can correspond to one or more of an ID of a PRU, a PRS resource ID, a PRS resource set ID, and a PRS ID.

For example, a second part can include a PRU CP report. A PRU can report the CP measurement result concerning the corresponding PRS resource ID, PRS resource set ID and PRS ID in LPP message, which can include various IEs. For example, the IE can correspond to one or more of an ID of a PRU, a CP measurement result, a PRS resource ID, a PRS resource set ID, and a PRS ID.

In a third part, an LMF can calculate the ARP location and CP error. For example, the third part can include an ARP error calculation (carrier phase error is omitted). Assume that the TRP antenna location is (x, y), APR error is (ex, ey), the actual ARP antenna location is (X, Y)=(x+ex, y+ey). The following calculation describe the calculation details for (ex, ey). Suppose the coordination of PRU 4 and PRU 5 are (x₄, y₄), (x₅, y₅) respectively. The measured PRS CP of PRU 4 and PRU 5 are φ₄, φ₅ respectively. The actual distance between TRP and PRU 4 is:

$${D}_{4} = \sqrt{{( X - {x}_{4} )}^{2} + {( Y - {y}_{4} )}^{2}} = λ ( N + {φ}_{4} / 2 π )$$

The actual distance between TRP and PRU 5 is:

$${D}_{5} = \sqrt{{( X - {x}_{5} )}^{2} + {( Y - {y}_{5} )}^{2}} = λ ( N + {φ}_{5} / 2 π )$$

where λ is the wavelength of measured PRS, N is the integer part, combining the above formula, the actual TRP antenna location (X, Y) can be calculated. The estimated APR error (ex, ey) can be calculated.

For example, the third part can include an error calculation (ARP error is omitted)/Assume that the actual antenna location of TRP is (X, Y), the coordination of PRU 4 and PRU 5 are (x₄, y₄), (x₅, y₅) respectively. The measured PRS CP of PRU 4 and PRU 5 are φ₄, φ₅, respectively. Suppose the initial CP error for TRP is Δφ, the following calculation describe the calculation details for Δφ. For example, the actual distance between TRP and PRU i (i=4 or 5) is, the following, and the estimated CP error for TRP Δφ can be calculated.

$${D}_{i} = \sqrt{{( X - {x}_{i} )}^{2} + {( Y - {y}_{i} )}^{2}} = λ [ N + ( {φ}_{i} + Δφ ) / 2 π ]$$

For example, the third part can include an ARP and CP error calculation. If both ARP and CP error exist, at least 3 PRUs are required to be calculated these error source values. Assume that there are 3 PRU (PRU i, PRU j, PRU k) meets the criterion for PRU selection (as listed in STEP 1), and the coordination of PRU i, PRU j, PRU k are (xi,yi), (xj,yj), (xk,yk) respectively. The measured PRS CP of PRU i, PRU j, PRU k are φᵢ, φⱼ, φₖ respectively. For example, actual distances between TRP and these PRUs are as follows, where by combining the below formulae, the actual TRP antenna location (X, Y) and phase error Δφ can be calculated.

$${D}_{i} = \sqrt{{( X - {x}_{i} )}^{2} + {( Y - {y}_{i} )}^{2}} = λ [ N + ( {φ}_{i} + Δφ ) / 2 π ]$$

$${D}_{j} = \sqrt{{( X - {x}_{j} )}^{2} + {( Y - {y}_{j} )}^{2}} = λ [ N + ( {φ}_{j} + Δφ ) / 2 π ]$$

$${D}_{k} = \sqrt{{( X - {x}_{k} )}^{2} + {( Y - {y}_{k} )}^{2}} = λ [ N + ( {φ}_{k} + Δφ ) / 2 π ]$$

In a fourth part, the LMF can transmit an error to the UE. For UE-based positioning, LMF can transmits various IEs to the target UE in LPP messages. For example, an IE can include one or more of an ARP error (if applicable), a CP error (if applicable), a PRS ID, a PRS resource ID, and a PRS resource set ID. For example, a UE can get more precise coordination evaluation result while calibrating the ARP error.

At least one aspect is directed to a UL SRS-CP measurement request and report. In 3GPP, LMF will send a measurement request signaling to the NG-RAN node, to get the required UL SRS measurement information. To get the UL SRS CP, LMF can request for the CP measurement result. The request can be added in the TRP measurement type, comprising the choice of UL SRS-CP. In return, NG-RAN node will send a measurement response signaling to the LMF, to report the UL SRS measurement result. To report the UL SRS CP, NG-RAN node can report the CP measurement result. The CP measurement result can be added in TRP measurement result IE, the IE comprising one or more of a UL SRS-CP, an additional Path List and CP, a UL SRS-CP quality, a positioning SRS Resource ID, and a positioning SRS Resource Set ID. The UL SRS-CP quality can provide an estimate of uncertainty of the CP measurement with the following options of CP quality value and CP quality resolution.

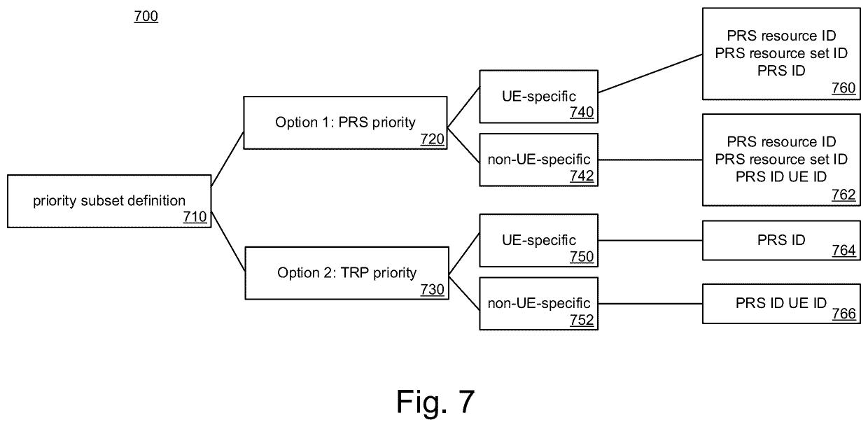

FIG. 7 depicts an example priority subset architecture, in accordance with present implementations. As illustrated by way of example in FIG. 7, an example priority subset architecture 700 can include at least a priority subset definition 710, a PRS priority option 720, a TRP priority option 730, PRS UE-specific modes 740 and non-UE-specific modes 742, TRP UE-specific modes 750 non-UE-specific modes 752, and corresponding IDs 760, 762, 764 and 766 At least one aspect is directed to priority subset definition. In a CP-assisted positioning procedure, LMF can provide UE with TRP or PRS subset, specifying the TRP/PRS info that a UE can measure with higher priority, means associated DL-PRS Resources the target device should prioritize for DL-PRS CP measurement reporting in measurement information.

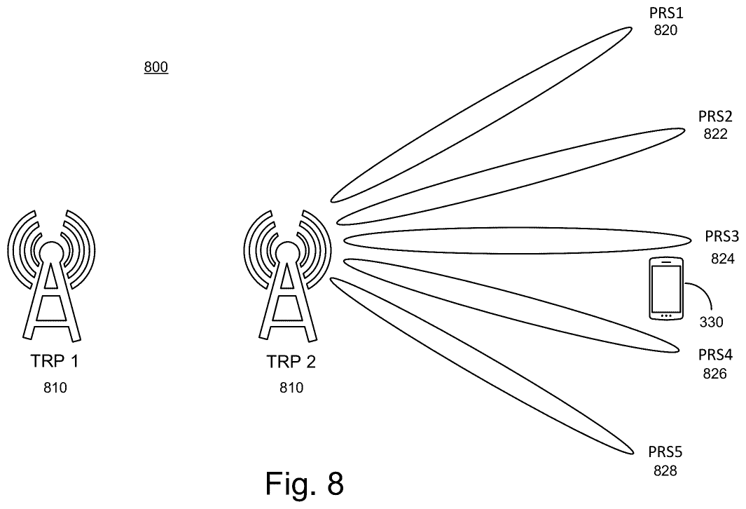

FIG. 8 depicts an example positioning configuration, in accordance with present implementations. As illustrated by way of example in FIG. 8, an example positioning configuration 800 can include at least TRPs 810, and PRS transmissions 820, 822, 824, 826 and 828. The TRP/PRS selection can satisfy the criterion that the transmission of PRS between TRP and UE is an LOS path. For example, from UE perspective, TRP2 may have higher CP measurement priority than that of TRP1. And among these transmitted PRS, PRS3 and PRS4 may have higher CP measurement priority than other PRS. For example, the TRP/PRS selection can include the various options.

A first option can correspond to PRS selection. The system can define configuration information including dl-PRS-ResourcePrioritySubsetl. When UE receives the specific PRS, the CP will be measured with high priority. For UE-specific signaling, the PRS subset can be specified in NR-DL-PRS-Info, containing dl-PRS-ResourcePrioritySubsetl for CP measurement priority. For example, the PRS subset can include or be associated with IEs including one or more of a PRS resource ID, a PRS resource set ID, and a PRS ID. For non-UE-specific signaling, an LMF may transmit the priority subset in other LPP message, such as PRS configuration info. The priority subset can include IEs including one or more of a PRS resource ID, a PRS resource set ID, a PRS ID, and a UE ID.

A second option can correspond to TRP selection. The system can define configuration information like dl-TRP-PrioritySubset. If the UE receives PRS from this TRP, the CP will be measured with high priority. For UE-specific signaling, the TRP subset can be specified in NR-DL-PRS-Info, containing dl-TRP-PrioritySubset for CP measurement priority. The TRP subset can include an IE for a PRS ID. Alternatively, an LMF can configure the priority indicator for each TRP to UE. If the transmission path of TRP and current UE is LOS path, the priority indicator can be set as 1, otherwise the priority indication is 0. For non-UE-specific signaling, an LMF may transmit the priority subset in other LPP message, such as PRS configuration info. The priority subset can include one or more IEs, including a PRS ID, and a UE ID. In this way, the positioning performance can be improved.

At least one aspect is directed to a measurement threshold configuration. For example, an LMF can configure a measurement threshold in a different positioning scene for a UE. For example, the configuration can include an IE for a measurement threshold. The threshold specifies whether UE should report single or multiple measurement results in CP-assisted positioning procedure. For example, if the configured measurement threshold is X, the UE may measure/report RSTD together with CP of current PRS when the RSRP>X. otherwise, the UE may only measure/report one of these two measurement attributes. With this method, the PRS with better quality can be measured, and the signals with low RSRP will not be measured. In this way, the carrier phase measurement can be more precise, further improve the positioning accuracy.

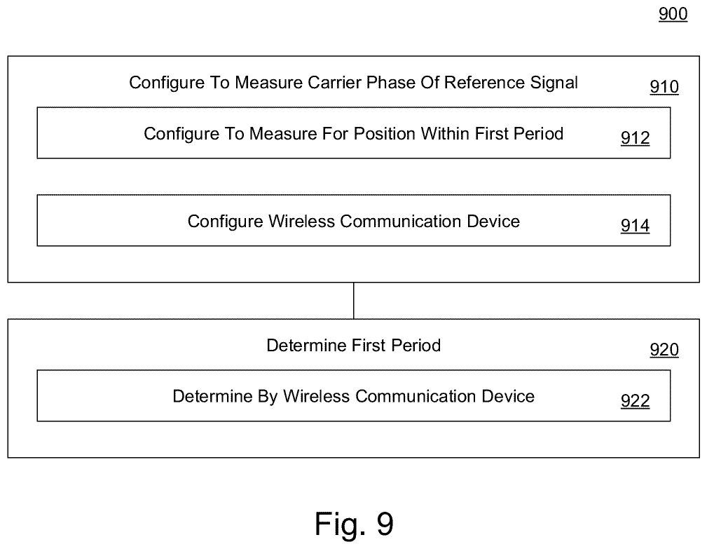

FIG. 9 depicts an example method of carrier phase positioning, in accordance with present implementations. At least one of BS 102 or UE 104 can perform method 900. At 910, the method 900 can configure to measure a carrier phase of a reference signal. At 912, the method 900 can configure to measure for position within the first period. At 914, the method 900 can configure the wireless communication device. At 920, the method 900 can determine a first period. At 922, the method 900 can determine by a wireless communication device.

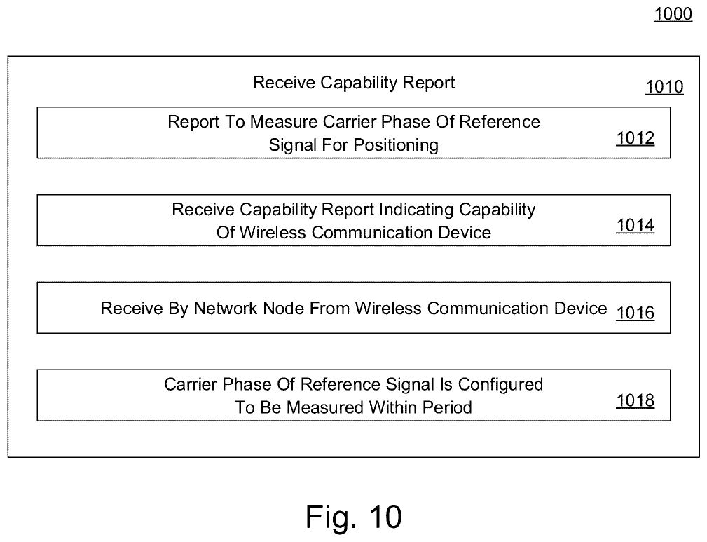

FIG. 10 depicts an example method of carrier phase positioning, in accordance with present implementations. At least one of BS 102 or UE 104 can perform method 1000. At 1010, the method 1000 can receive a capability report. At 1012, the method 1000 can report to measure a carrier phase of a reference signal for positioning. At 1014, the method 1000 can receive a capability report indicating capability of the wireless communication device. At 1016, the method 1000 can receive by a network node from a wireless communication device. At 1018, the method 1000 can carrier phase of the reference signal is configured to be measured within a period.

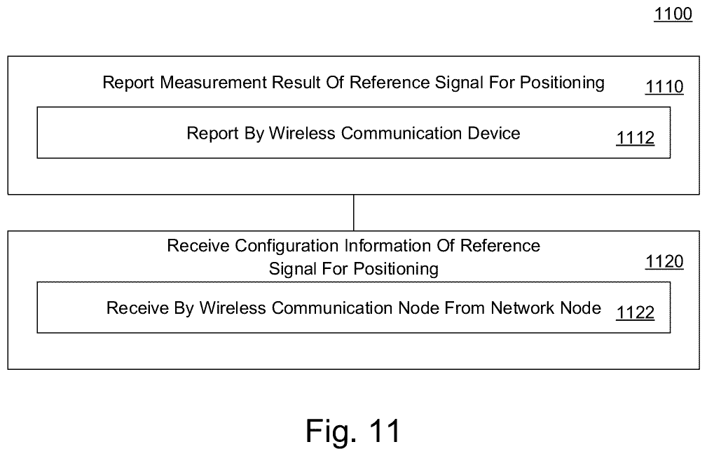

FIG. 11 depicts an example method of carrier phase positioning, in accordance with present implementations. At least one of BS 102 or UE 104 can perform method 1100. At 1110, the method 1100 can report a measurement result of a reference signal for positioning. At 1112, the method 1100 can report by a wireless communication device. At 1120, the method 1100 can receive configuration information of a reference signal for positioning. At 1122, the method 1100 can receive by a wireless communication node from a network node.

For example, the wireless communication method can include, in the first period, when the wireless communication device is in a first state, is defined as

$${T}_{CP , Total} = {\sum }_{i = 1}^{L} {T}_{CP , i} + ( L - 1 ) * {max}_{i = 1}^{L} ( {T}_{effect , i} )$$

$$where {T}_{CP , i} = ( {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} ,$$

where N_{RxBeam,i} is a UE Rx beam sweeping factor, CSSF_{PRS,i} is a carrier-specific scaling factor for NR PRS-based positioning measurements in positioning frequency layer i, K_{p,PRS,i} is a scaling factor for a positioning frequency layer to be measured within the associated measurement gap pattern, N_{PRS,i}^{slot} is a maximum number of DL PRS resources in positioning frequency layer i configured in a slot, L_{available_PRS,i} is a time duration of an available PRS in a positioning frequency layer i to be measured during T_{available_PRS,i}, Nₛₐₘₚₗₑ is a number of PRS carrier phase (CP) measurement samples, T_{last,i} is a measurement duration for a last PRS CP sample in positioning frequency layer i, T_{effect,i} is a periodicity of a PRS CP measurement in positioning frequency layer i.

For example, the first state is an RRC_CONNECTED state.

For example, the wireless communication method can include where the first period, when the wireless communication device is in a second state, is defined as

$${T}_{CP , Total} = {\sum }_{i = 1}^{L} {T}_{CP , i} + ( L - 1 ) * {max}_{i = 1}^{L} ( {T}_{effect , i} ) ,$$

$$where {T}_{CP , i} = ( {K}_{carrier \_ PRS} * {N}_{RxBeam , i} * ⌈ \frac{{N}_{PRS , i}^{slot}}{{N}^{′}} ⌉ * ⌈ \frac{{L}_{available \_ PRS , i}}{N} ⌉ * {N}_{sample} - 1 ) * {T}_{effect , i} + {T}_{last , i} ,$$

where K_{carrier_PRS} is a scaling factor for PRS-based NR positioning measurements in RRC_INACTIVE, N_{RxBeam,i} is a scaling factor for Rx beam sweeping, N_{PRS,i}^{slot} is a maximum number of DL PRS resources of positioning frequency layer i configured in a slot, N′ is UE capability for number of DL PRS resources that it can process in a slot, L_{available_PRS,i} is a time duration of available PRS to be measured in the positioning frequency layer i to be measured during T_{PRS,i}, Nₛₐₘₚₗₑ is a number of PRS CP measurement sample, Tₗₐₛₜ is a measurement duration for the last PRS CP sample, including the sampling time and processing time, T_{effect,i} is a periodicity of PRS CP measurement in positioning frequency layer i.

For example, the second state is an RRC_INACTIVE state.

For example, the wireless communication method can include a first capability of the wireless communication device to measure the carrier phase of the reference signal that is the same as second capability of the wireless communication device to measure one or more other measurement attributes of the reference signal.

For example, the wireless communication method can include a first capability of the wireless communication device to measure the carrier phase of the reference signal that is different with second capability of the wireless communication device to measure one or more other measurement attributes of the reference signal.

For example, the wireless communication method further can include sending, by the wireless communication device, a capability report indicating the first capability to measure the carrier phase of the reference signal.

For example, the wireless communication method further can include sending, by the wireless communication device, a capability report indicating the first capability to measure the carrier phase of the reference signal. For example, in the wireless communication method, the first capability is the carrier phase measurement capability, the second capability is other attribute measurement capability. For example, in the wireless communication method, the capability report further indicates a duration N of DL-PRS symbols in units of ms that the wireless communication device can process every T ms for carrier phase measurement.

For example, the wireless communication method can include applying, by the wireless communication device, a scaling factor for a Phase Error Group (PEG) to the first period. For example, the wireless communication method can include reporting, by the wireless communication device, a first scaling factor to measure the carrier phase of the reference signal. For example, the wireless communication method can include reporting, by the wireless communication device, a second scaling factor to measure one or more other measurement attributes of the reference signal. For example, in the wireless communication method, a second period, within which the wireless communication device is configured to measure the carrier phase and the one or more other measurement attributes is defined according to the first scaling factor and/or the second scaling factor.

For example, the wireless communication method can include where the second period is applied for ith one of a plurality of Positioning Frequency Layers (PFLs). For example, the wireless communication method can include where the second period is applied for all of a plurality of Positioning Frequency Layers (PFLs).

For example, the wireless communication method can include sending, by the wireless communication device, a capability report indicating its capability to measure the carrier phase of the reference signal together with one or more other measurement attributes. For example, in the wireless communication method, the capability report indicates at least one of (1) a duration N of DL-PRS symbols in units of ms that the wireless communication device can process every T ms. The method can include or (2) the one or more measurement attributes. For example, the method can include the capability report indicating at least at one of (1) a duration N of DL-PRS symbols in units of ms that the wireless communication device can process every T ms. The method can include (2) offsets for N and T, (3) the one or more measurement attributes.

For example, the wireless communication method can include the measurement attributes comprising an RSTD, a Reference Signal Received Power (RSRP), a Reference Signal Received Path Power (RSRPP), a UE Rx-Tx difference, or combinations thereof. For example, the wireless communication method can include applying, by the wireless communication device, a scaling factor for measuring one or more other measurement attributes to the first period. At least one aspect is directed to a method including transmitting, by a network node to a wireless communication node, configuration information of a reference signal for positioning. For example, in the wireless communication method, the configuration information is related to carrier phase error. For example, in the wireless communication method, ere the configuration information comprises at least one of. The method can include 1) ARP (antenna reference point) location error, 2) carrier phase error, 3) PRS ID, 4) PRS resource ID, 5) PRS resource set ID.

For example, the wireless communication method can include reporting, by a wireless communication node to a network node, the measurement result of a reference signal for positioning. For example, in the wireless communication method, the wireless communication is a positioning reference unit (PRU). For example, in the wireless communication method, the measurement result refers to the carrier phase measurement result. For example, in the wireless communication method, the reference signal for positioning is PRS. For example, in the wireless communication method, the carrier phase measurement result comprises at least one of 1) carrier phase of the PRS, 2) PRS ID, 3) PRS resource ID, 4) PRS resource set ID.

For example, the wireless communication method can include requesting, by a network node, a measurement result and/or measurement type of a reference signal for positioning. For example, in the wireless communication method, the measurement result refers to the carrier phase measurement result. For example, in the wireless communication method, the reference signal for positioning refers to UL pos-SRS (positioning sounding reference signal). For example, in the wireless communication method, the measurement type refers to TRP measurement type, which can include UL SRS-CP measurement. For example, in the wireless communication method, the carrier phase measurement result comprises at least one of 1) carrier phase measurement result, 2) additional path list and carrier phase, 3) UL SRS-CP measurement quality, 4) positioning SRS resource ID, 5) positioning SRS resource set ID. For example, in the wireless communication method, the UL SRS-CP quality comprises an estimate of uncertainty of the CP measurement. For example, in the wireless communication method, the estimate of uncertainty comprises at least one of 1) CP quality value and 2) CP quality resolution. For example, in the wireless communication method, the configuration information comprises a PRS subset configuration. For example, in the wireless communication method, the PRS subset configuration is defined for carrier phase measurement priority measurement. For example, in the wireless communication method, the PRS subset configuration comprises at least one of 1) PRS resource ID, 2) PRS resource set ID, or 3) PRS ID. For example, in the wireless communication method, the PRS subset configuration comprises at least one of 1) PRS resource ID, 2) PRS resource set ID, 3) PRS ID, or 4) UE ID.

For example, in the wireless communication method, the configuration information comprises a TRP subset configuration. For example, in the wireless communication method, the TRP subset configuration comprises PRS ID. For example, the method can include configuring, by the network node, the priority indicator. For example, in the wireless communication method, the priority indicator is associated with at least one PRS ID. For example, in the wireless communication method, the priority indicator is set as 1, in accordance with a determination that a transmission path of the TRP and the wireless communication device corresponds to an LOS path, and where the priority indicator is set as O in accordance with a determination that a transmission path of the TRP and the wireless communication device does not correspond to an LOS path. For example, in the wireless communication method, the configuration information can include a measurement threshold for the wireless communication device. For example, in the wireless communication method, the measurement threshold corresponds to RSRP of the PRS measurement threshold.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
determining, by a wireless communication device, a first period;
wherein the wireless communication device is configured to measure a carrier phase of a reference signal for positioning within the first period.

2. The wireless communication method of claim 1, wherein the first period, when the wireless communication device is in a first state, is defined as:
$${T}_{CP , Total} = {\sum }_{i = 1}^{L} {T}_{CP , i} + ( L - 1 ) * {max}_{i = 1}^{L} ( {T}_{effect , i} ) ,$$
$$where {T}_{CP , i} = ( {CSSF}_{PRS , i} * ceil ( {K}_{p , PRS , i} ) * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} ,$$
where N_{RxBeam,i} is a user equipment (UE) reception (Rx) beam sweeping factor, CSSF_{PRS,i} is a carrier-specific scaling factor for new radio (NR) positioning reference signal (PRS) based positioning measurements in positioning frequency layer i, K_{p,PRS,i} is a scaling factor for a positioning frequency layer to be measured within the associated measurement gap pattern, N_{PRS,i}^{slot} is a maximum number of downlink (DL) PRS resources in positioning frequency layer i configured in a slot, L_{available_PRS,i} is a time duration of an available PRS in a positioning frequency layer i to be measured during T_{available_PRS,i}, Nₛₐₘₚₗₑ is a number of PRS carrier phase (CP) measurement samples, T_{last,i} is a measurement duration for a last PRS CP sample in positioning frequency layer i, T_{effect,i} is a periodicity of a PRS CP measurement in positioning frequency layer i.

3. The wireless communication method of claim 2, wherein the first state is an RRC_CONNECTED state.

4. The wireless communication method of claim 1, wherein the first period, when the wireless communication device is in a second state, is defined as:
$${T}_{CP , Total} = {\sum }_{i = 1}^{L} {T}_{CP , i} + ( L - 1 ) * {max}_{i = 1}^{L} ( {T}_{effect , i} ) ,$$
$$where {T}_{CP , i} = ( {K}_{carrier \_ PRS} * {N}_{RxBeam , i} * ⌈ \frac{{N}_{PRS , i}^{slot}}{{N}^{′}} ⌉ * ⌈ \frac{{L}_{available \_ PRS , i}}{N} ⌉ * {N}_{sample} - 1 ) * {T}_{effect , i} + {T}_{last , i} ,$$
where K_{carrier_PRS} is a scaling factor for PRS-based NR positioning measurements in RRC_INACTIVE, N_{RxBeam,i} is a scaling factor for Rx beam sweeping, N_{PRS,i}^{slot} is a maximum number of DL PRS resources of positioning frequency layer i configured in a slot, N′ is UE capability for number of DL PRS resources that it can process in a slot, L_{available_PRS,i} is a time duration of available PRS to be measured in the positioning frequency layer i to be measured during T_{PRS,i}, Nₛₐₘₚₗₑ is a number of PRS CP measurement sample, Tₗₐₛₜ is a measurement duration for the last PRS CP sample, including the sampling time and processing time, T_{effect,i} is a periodicity of PRS CP measurement in positioning frequency layer i.

5. The wireless communication method of claim 4, where the second state is an RRC_INACTIVE state.

6. The wireless communication method of claim 1, wherein first capability of the wireless communication device to measure the carrier phase of the reference signal is same as second capability of the wireless communication device to measure one or more other measurement attributes of the reference signal.

7. The wireless communication method of claim 1, wherein first capability of the wireless communication device to measure the carrier phase of the reference signal is different with second capability of the wireless communication device to measure one or more other measurement attributes of the reference signal.

8. The wireless communication method of claim 6, further comprising:
sending, by the wireless communication device, a capability report indicating the first capability to measure the carrier phase of the reference signal.

9. The wireless communication method of claim 6, wherein the first capability is a carrier phase measurement capability, the second capability is other attribute measurement capability.

10. The method of claim 8, wherein the capability report further indicates a duration N of DL-PRS symbols in units of ms that the wireless communication device can process every T ms for carrier phase measurement, where T is an integer value.

11. The wireless communication method of claim 1, further comprising:
applying, by the wireless communication device, a scaling factor for a Phase Error Group (PEG) to the first period.

12. The wireless communication method of claim 1, further comprising:
reporting, by the wireless communication device, a first scaling factor to measure the carrier phase of the reference signal.

13. The wireless communication method of claim 1, further comprising:
reporting, by the wireless communication device, a second scaling factor to measure one or more other measurement attributes of the reference signal.

14. The wireless communication method of claim 13, wherein a second period, within which the wireless communication device is configured to measure the carrier phase and the one or more other measurement attributes is defined according to a first scaling factor and/or the second scaling factor.

15. The wireless communication method of claim 14, wherein the second period is applied for ith one of a plurality of Positioning Frequency Layers (PFLs).

16. The wireless communication method of claim 14, wherein the second period is applied for all of a plurality of Positioning Frequency Layers (PFLs).

17. The wireless communication method of claim 1, further comprising:
sending, by the wireless communication device, a capability report indicating its capability to measure the carrier phase of the reference signal together with one or more other measurement attributes.

18. The method of claim 17, wherein the capability report indicates at least one of: (1) a duration N of DL-PRS symbols in units of ms that the wireless communication device can process every T ms; or (2) the one or more measurement attributes, where N and T are each a respective integer value.

19. The method of claim 17, wherein the capability report indicates at least at one of: (1) a duration N of DL-PRS symbols in units of ms that the wireless communication device can process every T ms; (2) offsets for N and T, (3) the one or more measurement attributes, where N and T are each a respective integer value.

20. A wireless communication device, comprising:
at least one processor configured to:
determine a first period,
wherein the wireless communication device is configured to measure a carrier phase of a reference signal for positioning within the first period.
